(19) United States
(12) Patent Application Publication
(10) Pub. No.: US 2017/0189938 A1
(43) Pub. Date: Jul. 6, 2017

(54) SCRAPING CLEANER

(71) Applicant: Mark Ansted, Toledo, OH (US)

(72) Inventor: Mark Ansted, Toledo, OH (US)

(21) Appl. No.: 14/989,309

(22) Filed: Jan. 6, 2016

(51) Int. Cl. B08B 1/00; B05B 15/00; B05B 11/00; B08B 3/02; B08B 7/04

(52) U.S. Cl. CPC B08B 1/005; B08B 3/026; B08B 7/04; B05B 11/3014; B05B 15/005

(57) ABSTRACT

A scraping cleaner can include a bottle, a sprayer mechanism, and at least one scraping edge. The bottle can have a body portion extending along a vertical axis from a base that is substantially flat to a top that defines a connecting portion. The body portion can be configured to receive and retain a liquid cleaning solution in a cavity. The sprayer mechanism can include a pump assembly. The pump assembly can have a pump and a lever. The lever can be pivotally engaged with the pump such that pivoting movement of the lever induces the pump to draw the liquid cleaning solution from the cavity. The scraping edge is integral with the body portion and is positioned at the base. The at least one scraping edge extends along a path in a plane that is transverse to the vertical axis.

### BACKGROUND

1. Field

The present disclosure relates to a scraping device for cleaning.

2. Description of Related Prior Art

A scraper is a tool or device used for scraping, especially for removing dirt, paint, ice, or other unwanted matter from a surface.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A scraping cleaner can include a bottle, a sprayer mechanism, and at least one scraping edge. The bottle can be plastic and have a body portion and a connecting portion. The body portion can extend along a vertical axis from a base that is substantially flat to a top that defines the connecting portion. The body portion can define an aperture centered on the vertical axis and a cavity in fluid communication with the aperture. The body portion can be configured to receive and retain a liquid cleaning solution in the cavity. The sprayer mechanism can include a cap portion, a head and a pump assembly. The cap portion can be selectively engageable with the connecting portion to selectively close the cavity when engaged with the connecting portion. The head and the pump assembly can be engageable with the cap portion. The pump assembly can be mounted on the head and have a pump and a lever. The pump can include an inlet in fluid communication with the cavity and an outlet directed fluidly away from the cavity. The lever can be pivotally engaged with the pump such that pivoting movement of the lever induces the pump to draw the liquid cleaning solution from the cavity through the inlet and out of the outlet. The at least one scraping edge is integral with the body portion and is positioned at the base. The at least one scraping edge extends along a path in a plane transverse to the vertical axis.

### BRIEF DESCRIPTION OF THE DRAWINGS

The detailed description set forth below references the following drawings:

FIG. 1 is a perspective view of exemplary embodiment of the present disclosure;

FIG. 2 is a left-side view of the exemplary embodiment shown in FIG. 1;

FIG. 3 is a bottom portion of a front view of the exemplary embodiment shown in FIGS. 1 and 2;

FIG. 4 is a partial cross-section taken along section lines 4-4 in FIG. 3;

FIG. 5 is a partial cross-section analogous to FIG. 4 but of an alternative embodiment of the present disclosure;

FIG. 6 is a partial cross-section analogous to FIG. 4 but of an alternative embodiment of the present disclosure;

FIG. 7 is a bottom portion of a perspective view of an alternative embodiment of the present disclosure;

FIG. 8 is a bottom portion of a perspective view of an alternative embodiment of the present disclosure with a portion of the view magnified;

FIG. 9 is a partial cross-section analogous to FIG. 4 but of an alternative embodiment of the present disclosure; and

FIG. 10 is a bottom-up view of an alternative embodiment of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a tool for cleaning another structure. Embodiments of the present disclosure can include a bottle to hold cleaning fluid and a sprayer mechanism to spray the fluid on a structure to be cleaned. Embodiments of the present disclosure can also incorporate a scraping edge so that, after the structure has been sprayed with the fluid, the scraping edge can be applied to remove debris. The user need not carry a plurality of tools to accomplish cleaning. Further, the scraping edge can be incorporated with bottle when the bottle is formed. The scraping edge can be integrally-formed with respect to the bottle or be defined by an insert that is disposed in situ with respect to the bottle.

A scraping cleaner 10 can include a bottle 12, a sprayer mechanism 14, and at least one scraping edge 16. The bottle 12 can be plastic and be formed in a molding process, such as blow molding. Other plastic-forming processes can also be used to form bottles in one or more implementations of the present disclosure. The exemplary bottle 12 is illustrated as somewhat rectangular, but other shapes for a bottle can be applied in one or more other implementations of the present disclosure.

The bottle 12 can have a body portion 18 and a connecting portion 20. In the first exemplary embodiment, the body portion 18 and the connecting portion 20 are integrally-formed with respect to one another. “Integrally-formed” refers to the fact that in the exemplary embodiment the body portion 18 and the connecting portion 20 are formed together rather than being formed separately and then subsequently joined. The term defines a structural feature since structures that are integrally-formed are structurally different than structures that are comprised of subcomponents formed separately and then subsequently joined. “Integral” means consisting or composed of parts that together constitute a whole and thus encompasses structures of more than one part wherein the parts are either integrally-formed or formed separately and then subsequently joined.

The body portion 18 can extend along a vertical axis 22 from a base 24 that is substantially flat to a top 26 that defines the connecting portion 20. The connecting portion 20 can be shaped to include threads. The base 24 can be substantially flat and include a downwardly-facing and continuous perimeter extending in a single plane, wherein the scraping cleaner 10 can stand upright when the perimeter is resting on a surface. The base 24 need not be completely flat and can include recesses, and/or the perimeter need not be continuous, but the shape of bases in various implementations of the present disclosure can allow the scraping cleaner 10 to stand upright when the perimeter is resting on a surface.

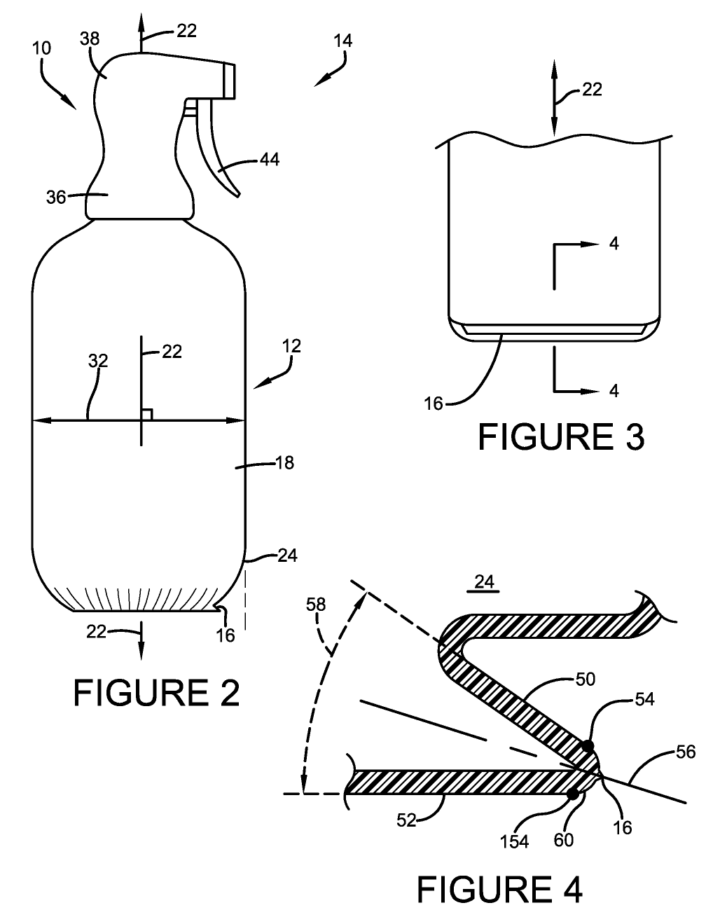

The body portion 18 can define an aperture 28 centered on the vertical axis 22 and a cavity 30 in fluid communication with the aperture 28. The body portion 18 can be configured to receive and retain a liquid cleaning solution 34 in the cavity 30. The choice of material for the body portion 18 is made based on the nature of the liquid cleaning solution 34. The body portion 18 defines a maximum width in a plane perpendicular to the vertical axis 22. The exemplary maximum width is referenced in FIG. 2 at 32.

The sprayer mechanism 14 can include a cap portion 36, a head 38 and a pump assembly 40. The cap portion 36 can be selectively engageable with the connecting portion 20 to selectively close the cavity 30 when engaged with the connecting portion 20. The cap portion 36 can be selectively engageable with the connecting portion 20 in that the cap portion 36 can be mounted on the connecting portion 20 to accomplish closure of the cavity 30; cap portion 36 can be removed connecting portion 20 without damage to cap portion 36 or connecting portion 20 and re-attached to again accomplish closure of the cavity 30; cap portion 36 or connecting portion 20 can be replaced with a newer version and engage the remaining component.

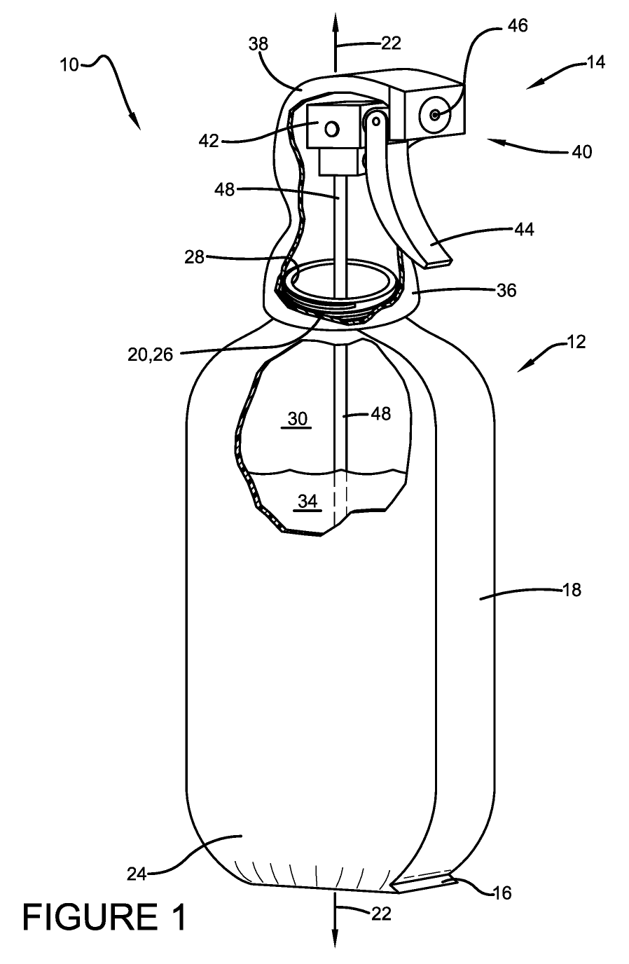

The head 38 and cap portion 36 are partially cut-away in FIG. 1 to show the exemplary interconnection between the cap portion 36 and the connecting portion 20 through mating threads. The head 38 and the pump assembly 40 can be engageable with the cap portion 36. The exemplary head 38 and cap portion 40 are integrally-formed with respect to one another. The pump assembly 40 can be mounted on the head 38 and have a pump 42 and a lever 44. The pump 42 can be engaged with the head 38 such that rotation of the pump 42 relative to the head 38 is prevented. The pump 42 include an inlet in fluid communication with the cavity 30 and an outlet 46 directed fluidly away from the cavity 30. FIG. 1 shows that the pump assembly 40 can also include a conduit 48 and the inlet (not visible in FIG. 1) can be positioned in cavity 30 near the base 24. The lever 44 can be pivotally engaged with the pump 42 such that pivoting movement of the lever 44 induces the pump 42 to draw the liquid cleaning solution 34 from the cavity 30 through the inlet and out of the outlet 46.

The at least one scraping edge 16 is integral with the body portion 18 and is positioned at the base 24. The at least one scraping edge 16 extends along a path in a plane that is transverse to the vertical axis 22. The scraping edge 16 can extend along a path in a plane transverse to the vertical axis 22 and is thus not flashing or a parting line resulting from the intersection of mold halves. The plane is referenced in FIG. 4 at 56. Venting can be applied in a mold to draw plastic into the portion of the mold cavity 30 that will form the at least one scraping edge 16 so that the scraping edge 16 has a radius of minimum size. A user can spray the liquid cleaning solution 34 on debris with the sprayer mechanism 14 and then scrape the debris off the underlying surface with the scraping edge 16 in one, relatively easy arm motion.

Referring now FIG. 4, in the first embodiment of the present disclosure, the body portion 18 can include a first surface 50 and a second surface 52. The exemplary second surface 52 can define at least a portion of the perimeter of the base 24 which supports the scraping cleaner 10 in a vertical orientation. The first and second surfaces 50, 52 are distinct from one another and converge toward one another along respective first sides 54, 154. The first sides 54, 154 of the first and second surfaces 50, 52 define boundaries of the first and second surfaces 50, 52. The at least one scraping edge 16 is positioned between the respective first sides 54, 154 in that the plane 56 contains the scraping edge 16 extends between the first sides 54, 154.

In the first embodiment, the first surface 50 and the second surface 52 can be planar. The first surface 50 and the second surface 52 can be transverse to one another. In the first exemplary embodiment, the first surface 50 and the second surface 52 can be at angle 58 of less than sixty degrees relative to one another. The respective first sides 54, 154 of the first surface 50 and the second surface 52 are spaced one another and the at least one scraping edge 16 is defined on a third surface 60 interconnecting the first surface 50 and the second surface 52. The exemplary third surface 60 is arcuate, defined by a radius. The sized of the radius can be minimized. The radius equal to or less than sixteen millimeters or more preferably equal to or less than eight millimeters.

As best shown in FIG. 2, the at least one scraping edge 16 is recessed from the maximum width 32 and is positioned closer to the vertical axis 22 than the maximum width. This allows the scraping edge 16 to be formed on the bottle 12 without increasing the shelf-space required for the displaying the embodiment on a store shelf. Existing spray bottle assemblies can be modified to incorporate the scraping edge 16 without increasing the shelf-space required for the displaying these modified spray bottle assemblies on a store shelf.

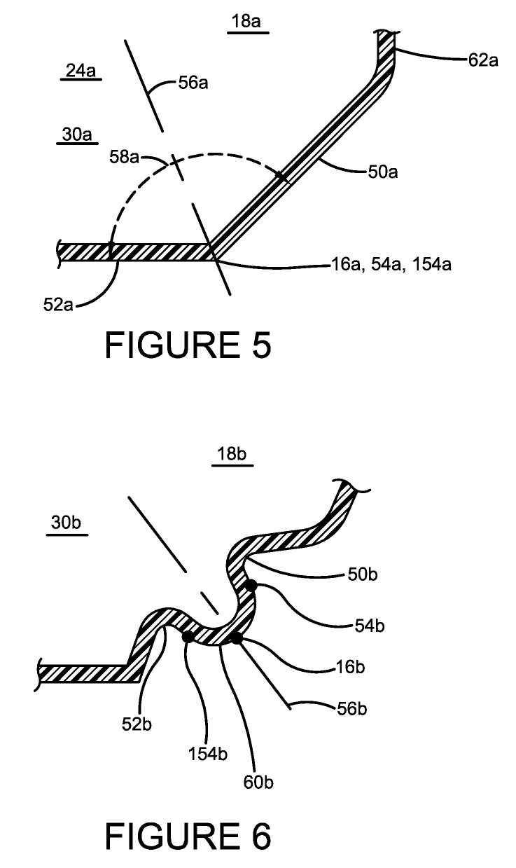

Referring now FIG. 5, in a second embodiment of the present disclosure, a body portion 18a can include a first surface 50a and a second surface 52a. The exemplary second surface 52a can define at least a portion of the perimeter of a base 24a which supports a scraping cleaner in a vertical orientation. The first and second surfaces 50a, 52a are distinct from one another and converge toward one another along respective first sides 54a, 154a. The first sides 54a, 154a of the first and second surfaces 50a, 52a define boundaries of the first and second surfaces 50a, 52a.

In the second embodiment, the first surface 50a and the second surface 52a are planar transverse to one another. The at least one scraping edge 16a is positioned at both of the respective first sides 54a, 154a in the plane 56a containing the scraping edge 16a, as the first sides 54a, 154a and the scraping edge 16a can be merged and extend along the same path. The first surface 50a and the second surface 52a thus intersect one another at the at least one scraping edge 16 and forming a chamfer between a bottom surface of the base 24 (defined at least in part by the second surface 52) and a side surface 62a of the body portion 18a. The first surface 50a and the second surface 52a are further defined as being in respective planes that are at angle 58a of greater than ninety degrees relative to one another, wherein the angle 58a defined from the perspective of the cavity 30a.

Referring now FIG. 6, in a third embodiment of the present disclosure, a body portion 18b can include a first surface 50b and a second surface 52b. The first and second surfaces 50b, 52b are distinct from one another and converge toward one another along respective first sides 54b, 154b. The first sides 54b, 154b of the first and second surfaces 50b, 52b define boundaries of the first and second surfaces 50b, 52b. The at least one scraping edge 16b is positioned between the respective first sides 54b, 154b in that a plane 56b containing the scraping edge 16b extends between the first sides 54b, 154b.

In the third embodiment, the first surface 50b and the second surface 52b are arcuate and convex from the perspective of a cavity 30b. The scraping edge 16b is defined on a third surface 60b that is arcuate and interconnects the first surface 50b and the second surface 52b. The third surface 60b is concave from the perspective of the cavity 30b.

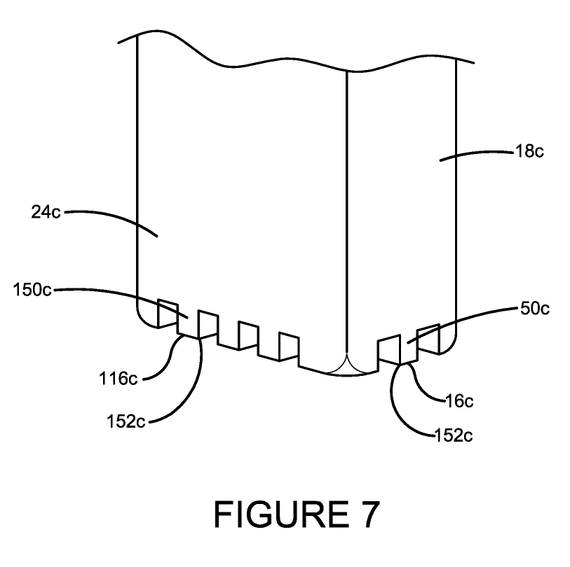

Referring now FIG. 7, a fourth embodiment of the present disclosure can include a plurality of scraping edges, such as scraping edges 16c and 116c. The exemplary scraping edges 16c and 116c can be flush with different sides of a body portion 18c. The body portion 18c can include sets of respect first surfaces 50c, 150c and second surfaces 52c, 152c. The exemplary second surfaces 52c, 152c can define portions of the perimeter of a base 24c which supports a scraping cleaner in a vertical orientation. The first and second surfaces 50c, 52c, 150c, 152c are distinct from one another. The surfaces 50c, 52c converge toward one another and intersect at the scraping edge 16c. The surfaces 150c, 152c converge toward one another and intersect at the scraping edge 116c. The scraping edges 16c, 116c extend along respective paths in different planes.

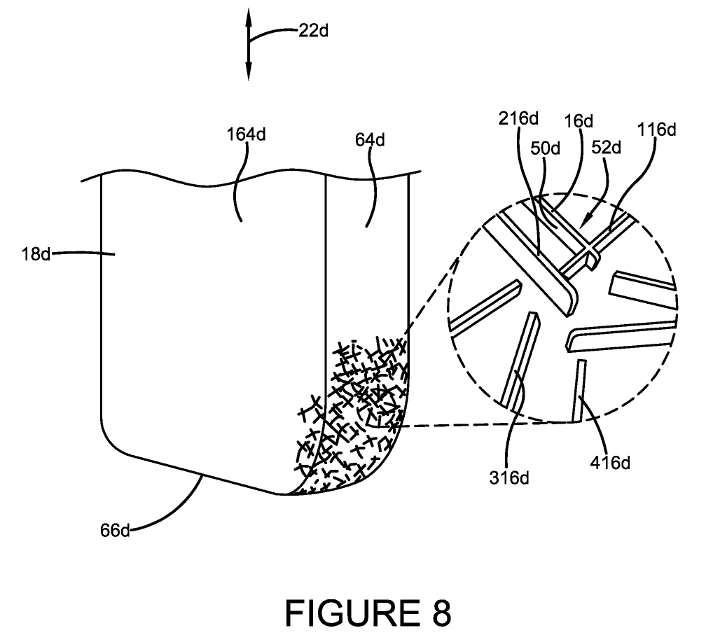

Referring now FIG. 8, a fifth embodiment of the present disclosure can include a plurality of scraping edges, such as scraping edges 16d, 116d, 216d, 316d, 416d. A body portion 18d can include a first surfaces on opposite sides of each of the scraping edges 16d, 116d, 216d, 316d, 416d. For example, the body portion 18d can include surfaces 50d and 52d that are distinct from one another and converge toward one another toward the scraping edge 16d. In the fifth embodiment, the plurality of scraping edges 16d, 116d, 216d, 316d, 416d can extend along respective paths in different planes. The scraping edges 16d, 116d, 216d, 316d, 416d can each project away from side walls 64d, 164d of the body portion 18d and be spaced from a bottommost surface 66d of the base 24. Various scraping edges 16 can intersect one another such as scraping edges 16d and 116d. The scraping edges 16d, 116d, 216d, 316d, 416d may be positioned on only one side of the body portion 18d and only below a midpoint of the body portion 18d along the vertical axis 22d. For example, scraping edges 16d, 116d, 216d, 316d, 416d may be positioned on only one bottom corner of the body portion 18d. The scraping edges 16d, 116d, 216d, 316d, 416d can be formed as an irregular or regular surface finish of the body portion 18d.

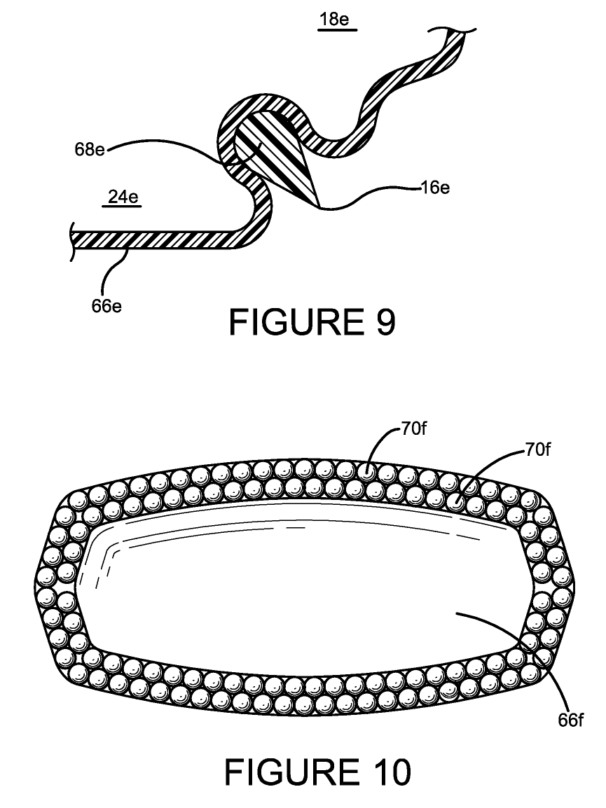

Referring now FIG. 9, in a sixth embodiment of the present disclosure, a scraping edge 16e can be defined by a solid and non-hollow scraper member 68e that is positioned in situ with respect to a body portion 18e. The body portion 18e is part of a bottle having a base 24e with a bottommost surface 66e. “In situ” refers to the structural nature of the body portion 18e being integral with and substantially surrounding the scraper member 68e such that the scraper member 68e cannot be removed from the body portion 18e without deforming or breaking the body portion 18e. Thus, the term “in situ” defines structure. The scraper member 68e can be placed in a mold or cast and the body portion 18e is dispensed in non-solid form in the mold or cast and flows around at least a portion of the scraper member 68e. The body portion 18e cools and hardens or sets around the scraper member 68e. In situ is the structural aspect of the engagement between the two parts and the casting or molding is the method applied to arrive at the structural aspect. At least a portion of the body portion 18e surrounds at least a portion of the scraper member 68e and thereby prevents separation of the scraper member 68e from the body portion 18e.

FIG. 10 is a bottom-up view of an alternative embodiment of the present disclosure. A plurality of projections 70f can extend from a bottommost surface 66f The projections 70f can be sized to be approximately one-eighth of one inch in diameter and have a height from the bottommost surface 66f of approximately one-eighth of one inch.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A scraping cleaner comprising:
a bottle being plastic and having a body portion and a connecting portion, said body portion extending along a vertical axis from a base that is substantially flat to a top that defines said connecting portion, said body portion defining an aperture centered on said vertical axis and a cavity in fluid communication with said aperture, said body portion configured to receive and retain a liquid cleaning solution in said cavity;
a sprayer mechanism including a cap portion, a head and a pump assembly, said cap portion selectively engageable with said connecting portion to selectively close said cavity when engaged with said connecting portion, said head and said pump assembly engageable with said cap portion, said pump assembly mounted on said head and having a pump and a lever, said pump including an inlet in fluid communication with said cavity and an outlet directed fluidly away from said cavity, said lever pivotally engaged with said pump such that pivoting movement of said lever induces said pump to draw the liquid cleaning solution from said cavity through said inlet and out of said outlet; and
at least one scraping edge integral with said body portion and positioned at said base, said at least one scraping edge extending along a path in a plane transverse to said vertical axis.

2. The scraping cleaner of claim 1 wherein said body portion further comprises:
a first surface; and
a second surface, said first and second surfaces distinct from one another and converging toward one another along respective first sides, said at least one scraping edge positioned between said respective first sides.

3. The scraping cleaner of claim 2 wherein said first surface and said second surface are further defined as planar.

4. The scraping cleaner of claim 3 wherein said first surface and said second surface are further defined as transverse to one another.

5. The scraping cleaner of claim 4 wherein said respective first sides of said first surface and said second surface intersect one another at said at least one scraping edge.

6. The scraping cleaner of claim 5 wherein said first surface and said second surface are further defined as being in respective planes that are at angle of greater than ninety degrees relative to one another, said angle defined from the perspective of said cavity.

7. The scraping cleaner of claim 4 wherein said respective first sides of said first surface and said second surface are spaced one another and said at least one scraping edge is defined on a third surface interconnecting said first surface and said second surface.

8. The scraping cleaner of claim 7 wherein said third surface is arcuate.

9. The scraping cleaner of claim 8 wherein said third surface has a radius equal to or less than sixteen millimeters.

10. The scraping cleaner of claim 9 wherein said third surface has a radius equal to or less than eight millimeters.

11. The scraping cleaner of claim 2 wherein said first surface and said second surface are further defined as arcuate and convex from the perspective of said cavity.

12. The scraping cleaner of claim 11 wherein said at least one scraping edge is defined on a third surface that is arcuate and interconnects said first surface and said second surface and wherein said third surface is further defined as concave from the perspective of said cavity.

13. The scraping cleaner of claim 2 wherein said at least one scraping edge body portion is further defined as a plurality of scraping edges.

14. The scraping cleaner of claim 13 wherein at least two of said plurality of scraping edges extend along respective paths in different planes.

15. The scraping cleaner of claim 14 wherein at least two of said plurality of scraping edges project away from a side wall of said body portion, spaced from a bottommost surface of said base.

16. The scraping cleaner of claim 15 wherein at least two of said plurality of scraping edges intersect one another.

17. The scraping cleaner of claim 16 wherein at least two of said plurality of scraping edges are positioned on only one side of said body portion and only below a midpoint of said body portion along said vertical axis.

18. The scraping cleaner of claim 2 wherein said at least one scraping edge and said body portion are further defined as integrally-formed with respect to one another.

19. The scraping cleaner of claim 1 wherein said at least one scraping edge is defined by a solid and non-hollow scaper member that is positioned in situ with respect to said body portion such that at least a portion of said body portion surrounds at least a portion of said scaper member and thereby prevents separation of said scraper member from said body portion.

20. The scraping cleaner of claim 1 wherein said body portion defines a maximum width in a plane perpendicular to said vertical axis and said at least one scraping edge is recessed from said maximum width and is positioned closer to said vertical axis than said maximum width.
